(19) United States
(12) Patent Application Publication
(10) Pub. No.: US 2019/0317322 A1
(43) Pub. Date: Oct. 17, 2019

(54) HEAD-UP DISPLAY DEVICE

(71) Applicant: DENSO CORPORATION, Kariya-city (JP)

(72) Inventors: Yuichiro HAYAKAWA, Kariya-city (JP); Takashi TAKAZAWA, Kariya-city (JP); Makoto SAKAI, Kariya-city (JP)

(21) Appl. No.: 16/454,491

(22) Filed: Jun. 27, 2019

Related U.S. Application Data
(63) Continuation of application No. PCT/JP2017/046323, filed on Dec. 25, 2017.

(30) Foreign Application Priority Data
Feb. 3, 2017 (JP) 2017-018664

(51) Int. Cl. G02B 27/01; B60K 35/00

(52) U.S. Cl. CPC G02B 27/0101; B60K 35/00; B60K 2370/1529; G02B 2027/0147; G02B 2027/011; G02B 2027/0127; G02B 2027/0145; B60K 2370/1526

(57) ABSTRACT

A head-up display device projects a near display image and a far display image onto a windshield to visibly display a near virtual image and a far virtual image imaged at different positions from each other. The head-up display device includes a magnification optical element and a correction optical element in addition to a first display surface that emits and displays the near display image and a second display surface that emits and displays the far display image. The magnification optical element magnifies the light emitted from the first display surface and the second display surface and reflects the light toward the windshield. The correction optical element is provided in an optical path of the light of the far display image, and corrects an optical influence, together with the magnification optical element, to be generated in the far virtual image by the reflection on the windshield.

### CROSS REFERENCE TO RELATED APPLICATIONS

The present application is a continuation application of International Patent Application No. PCT/JP2017/046323 filed on Dec. 25, 2017, which designated the United States and claims the benefit of priority from Japanese Patent Application No. 2017-018664 filed on Feb. 3, 2017. The entire disclosures of all of the above applications are incorporated herein by reference.

### TECHNICAL FIELD

The present disclosure relates to a head-up display device.

### BACKGROUND ART

Conventionally, a head-up display device (hereinafter, HUD device) is known, which projects a display image on a windshield of a vehicle to display a virtual image of the projected display image so as to be visible by a driver.

### SUMMARY

In one aspect of the present disclosure, a head-up display device that projects two display images on a windshield of a mobile unit to display virtual images of the two display images at different positions to be visible for an occupant of the mobile unit, includes: a first display surface configured to emit a near display image to display a near virtual image at a position near the windshield, of the two display images; a second display surface configured to emit a far display image to display a far virtual image at a position farther from the windshield than the near virtual image, of the two display images; a magnification optical element configured to magnify light emitted from the first display surface and the second display surface and to reflect the light toward the windshield to form the near virtual image and the far virtual image respectively magnified from the near display image and the far display image; and a correction optical element provided in an optical path of the light of the far display image. The correction optical element is configured to correct an optical influence, with the magnification optical element, to be generated in the far virtual image by a reflection on the windshield.

### BRIEF DESCRIPTION OF DRAWINGS

FIG. 1 is a diagram showing a configuration of a HUD device according to a first embodiment.

FIG. 2 is a block diagram showing an electrical configuration of the HUD device.

FIG. 3 is a diagram showing a configuration of a HUD device according to a second embodiment.

FIG. 4 is a diagram showing a configuration of a HUD device according to a third embodiment.

FIG. 5 is a diagram showing a configuration of a HUD device according to a fourth embodiment.

FIG. 6 is a diagram showing a configuration of a HUD device according to a fifth embodiment.

### DETAILED DESCRIPTION

To begin with, examples of relevant techniques will be described.

A head-up display device (hereinafter, HUD device) projects a display image on a windshield of a vehicle to display a virtual image of the projected display image so as to be visible by a driver. The HUD device projects two display images on a windshield to form the virtual images of the display images at different positions.

The HUD device includes: two screens; a projection device for displaying a first display image and a second display image on respective screens; and a concave mirror for reflecting light of each display image emitted from each screen toward a windshield. The projection device has an imaging position adjustment mirror for reflecting the light emitted from the projector toward the two screens. The imaging position adjustment mirror has a free-form second reflective surface to adjust the difference in the imaging distance from the mirror to the respective screens.

Generally, a windshield of a mobile object such as a vehicle is formed in a curved shape. Therefore, when the display image is reflected by the windshield, the virtual image receives optical influence such as curvature of field or astigmatism. As the first virtual image and the second virtual image are formed at different positions, the optical influence is different between the virtual images due to the reflection at the windshield.

However, in the HUD device, the concave mirror is shared by the first display image and the second display image, for example, in order to suppress an increase in size. Therefore, the optical influence generated in each virtual image by the reflection on the windshield should be corrected substantially only by the concave mirror. The light of the first display image is imaged as the first virtual image at a position farther than the second virtual image while being able to receive only the optical correction similar to the light of the second display image. Even if the imaging performance of the second virtual image can be secured by devising the shape of the concave mirror, the imaging performance of the first virtual image is difficult to secure.

The present disclosure provides a HUD device capable of securing the imaging performance of two virtual images while a magnification optical element such as a concave mirror is shared.

In one aspect of the present disclosure, a head-up display device that projects two display images on a windshield of a mobile unit to display virtual images of the two display images at different positions to be visible for an occupant of the mobile unit, includes:

a first display surface configured to emit a near display image to display a near virtual image at a position near the windshield, of the two display images;

a second display surface configured to emit a far display image to display a far virtual image at a position farther from the windshield than the near virtual image, of the two display images;

a magnification optical element configured to magnify light emitted from the first display surface and the second display surface and to reflect the light toward the windshield to form the near virtual image and the far virtual image respectively magnified from the near display image and the far display image; and

a correction optical element provided in an optical path of the light of the far display image. The correction optical element is configured to correct an optical influence, with the magnification optical element, to be generated in the far virtual image by a reflection on the windshield.

Accordingly, the optical influence assumed to be generated in the far virtual image due to the reflection at the windshield can be corrected not only by the magnification optical element but also by the correction optical element. Therefore, while the magnification optical element reflects both the near display image and the far display image toward the windshield, the light of the far display image receives an optical correction different from the light of the near display image, and is imaged as a far virtual image at a position farther than the near virtual image.

Accordingly, it is possible to optimize the correction optical element to ensure the imaging performance of the far virtual image after optimizing the magnification optical element to secure the imaging performance of the near virtual image. Therefore, the head-up display device can secure the imaging performance of two virtual images while the two display images share the magnification optical element.

Hereinafter, various embodiments of the present disclosure will be described with reference to the drawings. In the following respective embodiments, corresponding structural elements are indicated by the same reference signs and may not be redundantly described in some cases. In a case where only a part of a structure is described in each of the following embodiments, the rest of the structure of the embodiment may be the same as that of previously described one or more of the embodiments. Besides the explicitly described combination(s) of structural components in each of the following embodiments, the structural components of different embodiments may be partially combined even though such a combination(s) is not explicitly explained as long as there is no problem. It should be understood that the unexplained combinations of the structural components recited in the following embodiments and modifications thereof are assumed to be disclosed in this description by the following explanation.

### First Embodiment

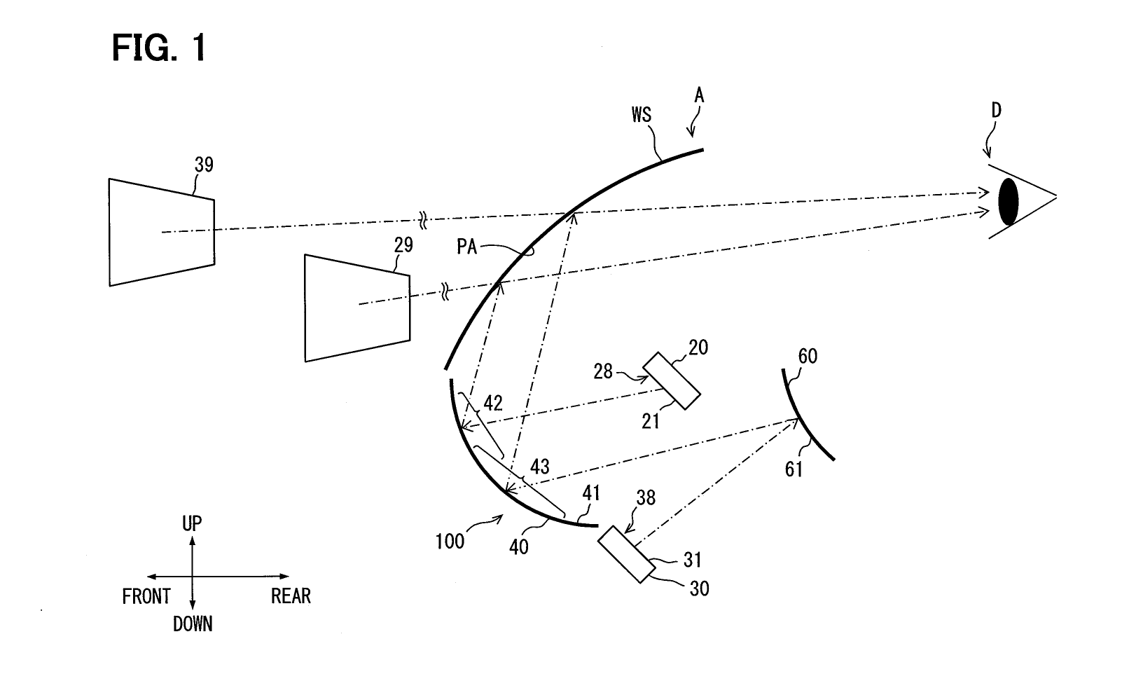

The HUD device 100 according to the first embodiment of the present disclosure shown in FIG. 1 is mounted on a vehicle A and provides various information related to the vehicle A to the driver D of the vehicle A. The HUD device 100 is disposed in front of a driver seat for the driver D, and is housed in the instrument panel of the vehicle A.

The HUD device 100 projects light of plural (e.g., two) display images onto a projection area PA of the windshield WS. The light projected on the windshield WS is reflected by the projection area PA toward the driver D, and reaches a predetermined eye box located around the head of the driver D. The driver D who positions the eye point in the eye box can see the light of the display image as a virtual image superimposed on the foreground scenery. The driver D can recognize various information by perceiving the virtual image. The various information displayed as virtual images includes vehicle state information such as the vehicle speed and the remaining amount of fuel, and navigation information such as route guidance.

The windshield WS is formed in a curved plate shape and is made of a translucent material such as glass. The windshield WS is disposed to be inclined with respect to the horizontal direction and the vertical direction of the vehicle A. The windshield WS functions as an optical system to form the virtual image. The projection area PA defined on the inner surface of the windshield WS is concave with a curvature continuously changing in both the lateral direction and the longitudinal direction in relation to the design of the vehicle A. The projection area PA may be formed of a vapor deposition film or a film, for example, for increasing the light reflectance, attached on the windshield WS.

The plural virtual images displayed by the HUD device 100 include a near virtual image 29 and a far virtual image 39. Each of the display possible range of the far virtual image 39 and the display possible range of the near virtual image 29 is shaped in a rectangle longer in the horizontal direction. The display possible size of the far virtual image 39 is larger than the display possible size of the near virtual image 29.

The near virtual image 29 and the far virtual image 39 are imaged at different positions in the front-rear direction of the vehicle A. The near virtual image 29 is formed at a position closer to the windshield WS than the far virtual image 39. More specifically, the near virtual image 29 is formed in a space of about 2 to 3 meters from the eye point in front of the vehicle A. The far virtual image 39 is formed at a position farther from the windshield WS than the near virtual image 29. More specifically, the far virtual image 39 is formed in a space of about 10 to 20 meters from the eye point in front of the vehicle A. As an example, the near virtual image 29 is displayed about 2 m in front of the eye point, and the far virtual image 39 is displayed about 15 m in front of the eye point.

The imaging positions of the near virtual image 29 and the far virtual image 39 are different also in the vertical (up-down) direction in the view of the driver D. The imaging position of the near virtual image 29 is set to be slightly below the eye point. That is, the near virtual image 29 is below the far virtual image 39. For example, a vehicle speed, an indicator, an icon, and the like are displayed as the near virtual image 29. The imaging position of the far virtual image 39 is set to be approximately the same height as the eye point. The far virtual image 39 functions as an augmented reality (AR) display by being superimposed on the road surface in the view of the driver D. For example, an arrow instructing a turn to the left or right is displayed as the far virtual image 39.

The lower edge of the far virtual image 39 may be located lower than the upper edge of the near virtual image 29 when viewed from the driver D. For example, the range in which the far virtual image 39 can be displayed may be a partially-cutout rectangular shape to avoid the range in which the near virtual image 29 can be displayed. Further, the lower edge of the far virtual image 39 and the upper edge of the near virtual image 29 may be separated from each other in the up-down direction, as viewed from the driver D.

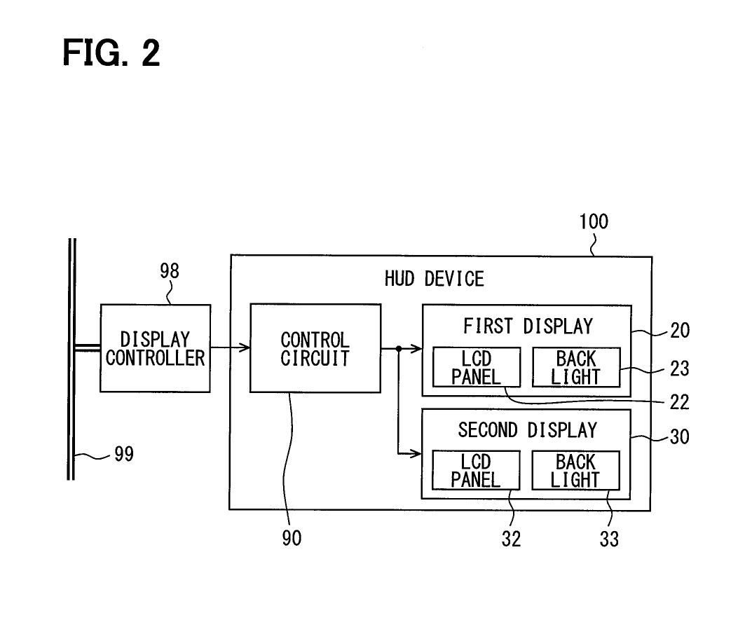

Next, the configuration of the HUD device 100 will be described. As shown in FIGS. 1 and 2, the HUD device 100 includes a first display 20, a second display 30, a control circuit 90, a magnification optical element 40, and a correction optical element 60.

The first display 20 is configured to emit the light of the near display image 28 toward the magnification optical element 40 to be formed as the near virtual image 29. The first display 20 has a first display surface 21 for emitting and displaying the near display image 28. The first display 20 is fixed, for example, on a housing or the like of the HUD device 100 such that the first display surface 21 faces the magnification optical element 40. The first display 20 is disposed behind the magnification optical element 40 and above the second display 30. The first display 20 is disposed closer to the magnification optical element 40 than the correction optical element 60 is. The first display 20 includes a liquid crystal display panel 22 and a backlight 23.

The liquid crystal display panel 22 forms the first display surface 21. The first display surface 21 is a flat surface having substantially no curvature, and has a rectangular shape longer in the horizontal direction. The first display surface 21 has a large number of pixels two-dimensionally arranged. In each pixel, red, green, and blue subpixels are provided. The liquid crystal display panel 22 emits and displays various near display images 28 in color on the first display surface 21 by controlling the light transmittance of the subpixels.

The backlight 23 has plural LEDs that emit white light source light, and a prism that guides the light emitted from each LED to the liquid crystal display panel 22. The light emitted from each LED is guided to the back side of the first display surface 21 to transmit and illuminate the near display image 28 drawn on the first display surface 21. The light of the near display image 28 transmitted through the first display surface 21 is projected onto the magnification optical element 40.

The second display 30 is configured to emit the light of the far display image 38 toward the correction optical element 60 to be formed as the far virtual image 39. The second display 30 has a second display surface 31 for emitting and displaying the far display image 38. The second display 30 is fixed, for example, on the housing of the HUD device 100 such that the second display surface 31 faces the correction optical element 60. The second display 30 is located between the magnification optical element 40 and the correction optical element 60 in the front-rear direction of the vehicle A. The second display 30 is disposed below the magnification optical element 40 and the correction optical element 60. Similar to the first display 20, the second display 30 includes a liquid crystal display panel 32, and a backlight 33.

The liquid crystal display panel 32 forms the second display surface 31. Similar to the first display surface 21, the second display surface 31 is a flat surface having substantially no curvature, and has a rectangular shape longer in the horizontal direction. The area of the second display surface 31 is wider than the area of the first display surface 21. The second display surface 31 has a large number of pixels two-dimensionally arranged. The liquid crystal display panel 32 emits and displays various far display images 38 in color on the second display surface 31 by individually controlling the light transmittance of plural subpixels of each pixel.

The backlight 33 has substantially the same configuration as the backlight 23. The light emitted from each LED of the backlight 33 is guided to the back surface of the second display surface 31 to transmit and illuminate the far display image 38 drawn on the second display surface 31. The light of the far display image 38 transmitted through the second display surface 31 is reflected by the correction optical element 60 and projected on the magnification optical element 40.

The control circuit 90 controls the display of the near virtual image 29 and the far virtual image 39 by the HUD device 100. The control circuit 90 includes a microcontroller having a processor, a RAM, a storage medium, and the like. The control circuit 90 is electrically connected to the display control device 98 mounted on the vehicle A, the first display 20, the second display 30, and the like. The display control device 98 acquires information of the vehicle A through the on-vehicle communication bus 99, and determines the display mode of the near virtual image 29 and the far virtual image 39 corresponding to the situation. The control circuit 90 controls the first display 20 and the second display 30 based on the command signal from the display control device 98 to transmit information necessary for the driver D through the near virtual image 29 and the far virtual image 39 for the driver D.

The magnification optical element 40 is a reflective mirror in which a metal such as aluminum is vapor-deposited on the surface of a colorless and transparent substrate made of synthetic resin or glass. The magnification optical element 40 is formed in a rectangular plate shape longer in the horizontal direction as a whole. The magnification optical element 40 is curved so that the deposition surface of aluminum is concave. The magnification optical element 40 is disposed below the projection area PA and in front of the correction optical element 60. A magnification reflective surface 41 is formed on the magnification optical element 40. The magnification optical element 40 is held by the housing or the like of the HUD device 100 in a manner that the magnification reflective surface 41 is directed to the first display 20 and the correction optical element 60.

The magnification reflective surface 41 has a rectangular shape longer in the horizontal direction and has a wave shape curved in the thickness direction of the magnification optical element 40. The magnification reflective surface 41 is formed in a concave free-form surface having different curvatures in the longitudinal direction and the lateral direction. The curvature defined in each direction of the magnification reflective surface 41 may not be constant, and may be different between portions of the magnification reflective surface 41. The magnification reflective surface 41 is arranged to straddle both the optical path of the light of the near display image 28 and the optical path of the light of the far display image 38. The light of the near display image 28 emitted from the first display surface 21 and the light of the far display image 38 reflected by the correction optical element 60 both enter the magnification reflective surface 41. At least a part of the first incident area 42 on which the light of the near display image 28 is incident overlaps at least a part of the second incident area 43 on which the light of the far display image 38 is incident, on the magnification reflective surface 41. The first incident area 42 is located above the second incident area 43. The second incident area 43 is wider than the first incident area 42.

The magnification reflective surface 41 of the magnification optical element 40, which is curved in concave, enlarges the light of the far display image 38 and the far virtual image 39, and reflects the light upward to the windshield WS. The near virtual image 29 and the far virtual image 39, which are enlarged from the near display image 28 and the far display image 38, respectively, are imaged by the reflection on the magnification reflective surface 41. The enlargement factor of the far virtual image 39 with respect to the far display image 38 is larger than the enlargement factor of the near virtual image 29 with respect to the near display image 28.

The correction optical element 60 is a reflective mirror in which a metal such as aluminum is vapor-deposited on the surface of a colorless and transparent base material made of synthetic resin or glass, as in the case of the magnification optical element 40. The correction optical element 60 is formed in a rectangular plate shape smaller than the correction optical element 60 as a whole. The correction optical element 60 is curved so that the deposition surface of aluminum has a convex shape.

The correction optical element 60 is located in the optical path of the light of the far display image 38. The correction optical element 60 is held by the housing of the HUD device 100 behind the magnification optical element 40 and the second display 30. The correction optical element 60 is disposed slightly lower than the first display 20 in the vertical direction, and is disposed at a position farther from the magnification reflective surface 41 than the first display 20. The correction optical element 60 has the correction reflective surface 61. The correction optical element 60 is held by the housing or the like of the HUD device 100 in a manner that the correction reflective surface 61 is directed to the second display surface 31 and the magnification reflective surface 41. The correction optical element 60 is disposed between the first display surface 21 and the magnification optical element 40 in the optical path of the light of the far display image 38 from the first display surface 21 to the projection area PA. The optical path of the light of the far display image 38 from the correction reflective surface 61 to the second incident area 43 is defined not to overlap the first display 20.

The correction reflective surface 61 is formed in a concave free-form surface having different curvatures in the longitudinal direction and the lateral direction. The curvature defined in each direction of the correction reflective surface 61 may not be constant, and may be different between portions of the correction reflective surface 61. The light of the far display image 38 emitted from the second display surface 31 is incident on the correction reflective surface 61. The correction reflective surface 61 reflects the light of the far display image 38 emitted from the second display surface 31 frontward to the magnification optical element 40. Due to the optical function of the correction reflective surface 61, the correction optical element 60 makes an optical path distance from the second display surface 31 to the magnification reflective surface 41 longer than an optical path distance from the first display surface 21 to the magnification reflective surface 41.

In the HUD device 100, the windshield WS is used as an optical system for forming the virtual images 29 and 39. However, the windshield WS is not curved with an optically desirable curvature. Therefore, the near virtual image 29 and the far virtual image 39 receive optical influence due to the reflection on the projection area PA. Therefore, the optical elements provided in the HUD device 100, that is, the magnification optical element 40 and the correction optical element 60 are designed to correct the optical influence caused by the reflection on the windshield WS.

The optical influence is, for example, curvature of field and astigmatism. The curvature of field is a phenomenon in which a display image displayed in a flat shape is curved in the front-rear direction along the optical axis due to the concave shape of the projection area PA. The astigmatism is a phenomenon in which deformation occurs in the individual point images constituting the virtual image due to mismatch in focal length at each position of the projection area PA.

As described above, the magnification ratio is different between the near virtual image 29 and the far virtual image 39. Therefore, the optical effect on the far virtual image 39 caused by the reflection on the projection area PA is larger than the optical effect on the near virtual image 29 caused by the reflection on the projection area PA, along with the increase in the magnification ratio. In the HUD device 100, one magnification optical element 40 plays an optical role of reflecting each of the near display image 28 and the far display image 38, and is shared by the near virtual image 29 and the far virtual image 39. Therefore, it is difficult to make the curved shape of the magnification reflective surface 41 suitable for correcting both the near display image 28 and the far display image 38.

Therefore, the magnification reflective surface 41 is set to a curved shape suitable for correcting the optical influence generated in the near display image 28. When the distance to the imaging position is relatively short and the magnification ratio is small (for example, less than 10 times), the imaging performance of the near virtual image 29 can be sufficiently secured only by the magnification reflective surface 41, because being less susceptible to the shape of the windshield WS.

When the distance to the image forming position is relatively long (for example, 5 m or more) and the magnification ratio is also large (for example, 10 times or more) to perform AR display, the influence by the shape of the windshield WS is remarkable. Therefore, the optical influence generated in the far display image 38 is corrected by both the magnification reflective surface 41 and the correction reflective surface 61. More specifically, the correction reflective surface 61 is set to a curved shape suitable for correcting the optical influence generated in the far display image 38 which cannot be corrected by the magnification reflective surface 41. As described above, the correction optical element 60 corrects the curvature of field, astigmatism, and the like occurring in the far virtual image 39 together with the magnification optical element 40. As a result, the light of the far display image 38 is clearly imaged as the far virtual image 39 while passing through the correction optical element 60 and the magnification optical element 40 and being reflected by the projection area PA.

As described above, the optical influence assumed to be generated in the far virtual image 39 due to the reflection at the windshield WS can be corrected not only by the magnification optical element 40 but also by the correction optical element 60. Therefore, while the magnification optical element 40 is configured to reflect both the near display image 28 and the far display image 38, the light of the far display image 38 has an optical correction different from the light of the near display image 28, and is imaged as the far virtual image 39 at a position farther than the near virtual image 29.

Accordingly, after optimizing the magnification optical element 40 to secure the imaging performance of the near virtual image 29, the correction optical element 60 is optimized to secure the imaging performance of the far virtual image 39. Therefore, while the plural display images 28 and 38 share the magnification optical element 40, the HUD device 100 can ensure the imaging performance for each of the near virtual image 29 and the far virtual image 39.

According to the first embodiment, since the near virtual image 29 and the far virtual image 39 do not have independent magnification optical systems, the HUD device 100 can be downsized, and is easily mounted on the vehicle A. In addition, according to the adoption of the correction optical element 60, the imaging performance can be secured for the near virtual image 29 and the far virtual image 39 having largely different magnification ratios, without degradation in the imaging performances.

The correction optical element 60 of the first embodiment is located between the second display surface 31 and the magnification reflective surface 41. Therefore, the correction optical element 60 can correct the light of the far display image 38 at a stage before being enlarged by the magnification reflective surface 41. Thus, since the size of the correction optical element 60 can be kept small, the HUD device 100 can be downsized.

In the magnification reflective surface 41 of the first embodiment, the first incident area 42 and the second incident area 43 are defined to overlap with each other. According to such an optical system design, the magnification optical element 40 can be downsized. However, when at least a part of the first incident area 42 and at least a part of the second incident area 43 overlap with each other, the correction action that can be exerted by the magnification reflective surface 41 is substantially the same. Therefore, the configuration for correcting the optical influence generated in the far virtual image 39 by the addition of the correction optical element 60 is suitable when the first incident area 42 and the second incident area 43 overlap with each other, to secure the imaging performance of the two virtual images 29 and 39.

Furthermore, as in the first embodiment, when the correction optical element 60 is configured by a reflective mirror, the optical path of the light of the far display image 38 can be folded inside the HUD device 100. As a result, it is possible to reduce the dimension of the HUD device 100 in the front-rear direction. Accordingly, the HUD device 100 can be easily mounted on the vehicle A whose storage space is difficult to increase in the front-rear direction.

In the first embodiment, the correction reflective surface 61 corresponds to a reflective surface, the vehicle A corresponds to a mobile unit, and the driver D corresponds to an occupant.

### Second Embodiment

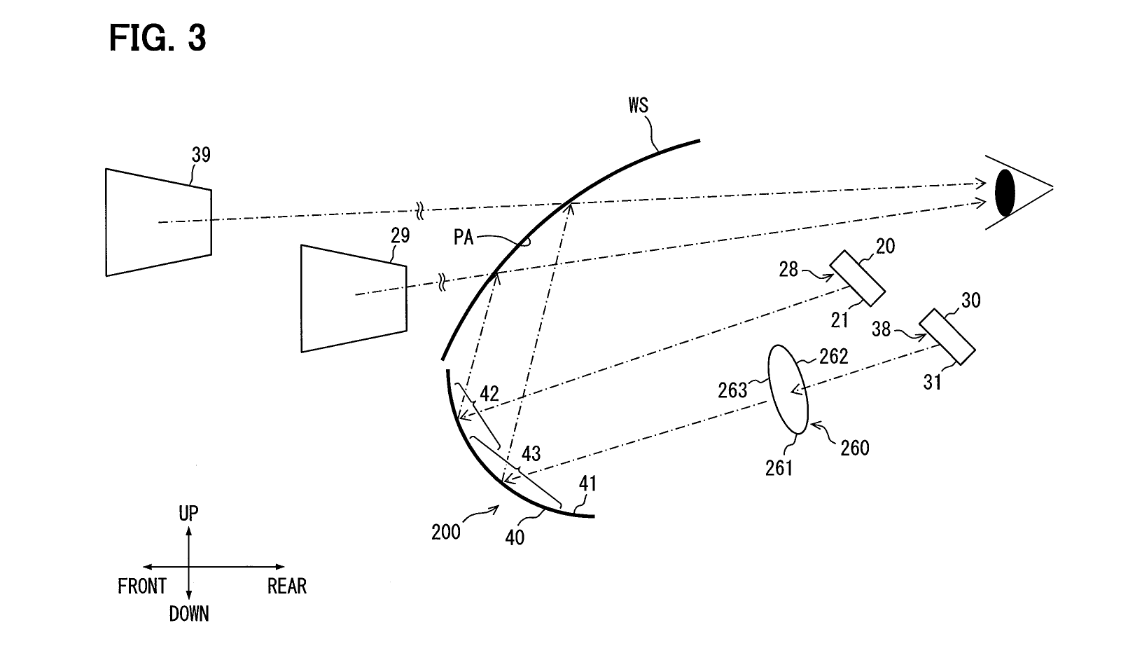

A second embodiment of the present disclosure shown in FIG. 3 is a modification of the first embodiment. In the HUD device 200 of the second embodiment, the arrangement of the first display 20 and the second display 30 is different from that of the first embodiment. In the second embodiment, an optical lens 261 is provided as the correction optical element 260.

The first display 20 is fixed to a housing or the like in a manner that the first display surface 21 faces the first incident area 42. The first display 20 is disposed above the optical lens 261. The distance from the magnification reflective surface 41 to the first display surface 21 is set to be longer than the distance from the magnification reflective surface 41 to the optical lens 261.

The second display 30 is disposed on the opposite side of the magnification reflective surface 41 with respect to the optical lens 261. The second display 30 is fixed to a housing or the like in a manner that the second display surface 31 is directed to the second incident area 43. The distance from the magnification reflective surface 41 to the second display surface 31 is set to be longer than the distance from the magnification reflective surface 41 to the first display surface 21. The optical path of the light of the far display image 38 is set below the optical path of the light of the near display image 28. The optical path of the light of the far display image 38 is defined along the optical path of the light of the near display image 28.

The optical lens 261 is formed of a highly translucent material such as glass. The optical lens 261 is, for example, a biconvex lens, a planoconvex lens, or a convex cylindrical lens. The pair of refractive surfaces 262 and 263 of the optical lens 261 may be convex cylindrical surface, spherical surface, aspheric surface, or free-form surface. One of the two refractive surfaces 262, 263 may be planar.

The optical lens 261 is disposed between the second display surface 31 and the second incident area 43. The optical lens 261 is fixed to a housing or the like at a position closer to the second display surface 31 than the second incident area 43. The optical lens 261 is provided at a position not overlapping the optical path of the light of the near display image 28 traveling from the first display surface 21 to the first incident area 42.

The refractive surface 262 faces the second display surface 31. The refractive surface 263 faces the second incident area 43. The light of the far display image 38 incident on the optical lens 261 from the second display 30 passes through the optical lens 261 and reaches the second incident area 43. The optical lens 261 refracts the light of the far display image 38 by the refractive surfaces 262 and 263 and emits the light toward the magnification optical element 40.

Each of the refractive surfaces 262, 263 has an optical function to correct the optical influence generated in the far display image 38, with the magnification reflective surface 41, like the correction reflective surface 61 (see FIG. 1) of the first embodiment. Specifically, each of the refractive surfaces 262 and 263 has an optimal shape to correct the optical effects generated in the far display image 38 due to the reflection at the projection area PA of the windshield WS, which cannot be corrected by the magnification reflective surface 41.

Also in the second embodiment, the optical lens 261 used as the correction optical element 260 achieves the same effect as the first embodiment, and can ensure the imaging performance of both the near virtual image 29 and the far virtual image 39. In the second embodiment, the second display 30 can be arranged side by side with the first display 20 by employing the transmissive correction optical element 260.

### Third Embodiment

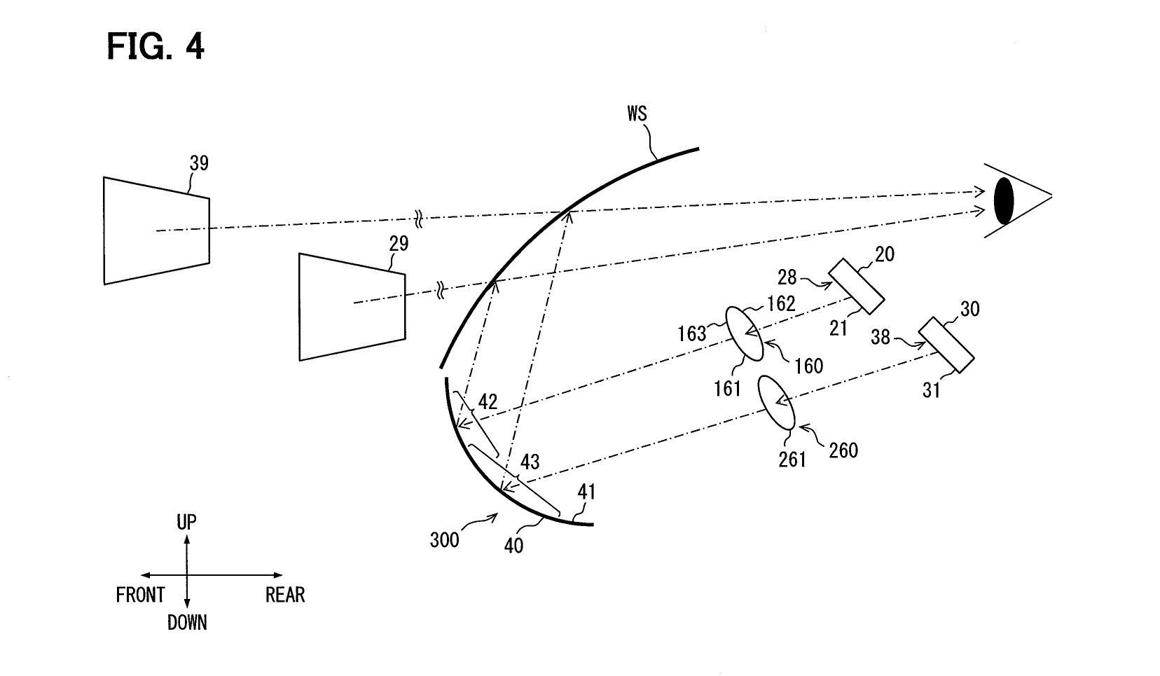

A third embodiment of the present disclosure shown in FIG. 4 is a modification of the second embodiment. The near correction optical element 160 is provided in the HUD device 300 of the third embodiment, in addition to the far correction optical element 260 substantially the same as the correction optical element of the second embodiment.

The near correction optical element 160 has an optical lens 161. The optical lens 161 is, like the optical lens 261, a biconvex lens, a planoconvex lens, a convex cylindrical lens, or the like formed of a material having high transparency such as glass. The optical lens 161 is disposed between the first display surface 21 and the first incident area 42. The optical lens 161 is fixed to a housing or the like at a position closer to the first display surface 21 than the first incident area 42. The optical lens 161 is arranged side by side with the optical lens 261, and is provided at a position not overlapping the optical path of the light of the far display image 38 traveling from the second display surface 31 to the second incident area 43.

The optical lens 161 has a refractive surface 162 facing the first display surface 21 and a refractive surface 163 facing the first incident area 42. The light of the near display image 28 incident on the optical lens 161 from the first display 20 is transmitted through the optical lens 161 and reaches the first incident area 42. The optical lens 161 refracts the light of the near display image 28 by the respective refractive surfaces 162 and 163 and emits the light toward the magnification optical element 40.

Each of the refractive surfaces 162 and 163 has an optical function of correcting the optical influence generated in the near display image 28 in cooperation with the magnification reflective surface 41. Specifically, each of the refractive surfaces 162 and 163 has an optimal free-form surface for correcting the optical effects generated in the near display image 28 due to the reflection by the windshield WS, which cannot be corrected by the magnification reflective surface 41.

Also in the third embodiment, the same effects as those of the second embodiment can be obtained, and the imaging performance can be secured for each of the near virtual image 29 and the far virtual image 39. In the third embodiment, the optical action of the near correction optical element 160 can more precisely correct the optical influence that is expected to occur in the near virtual image 29. Therefore, it is possible to further improve the imaging performance of each of the near virtual image 29 and the far virtual image 39 by adjusting the shapes of the near correction optical element 160 and the far correction optical element 260.

### Fourth Embodiment

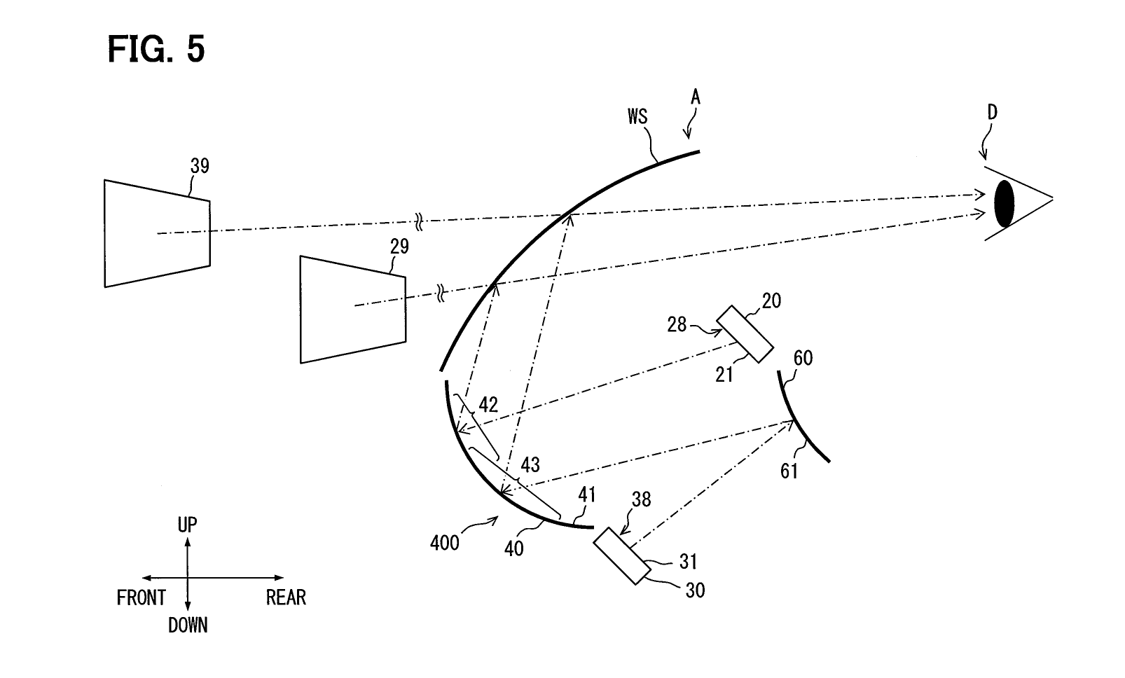

A fourth embodiment of the present disclosure shown in FIG. 5 is another modification of the first embodiment. In the fourth embodiment, the position of the first display 20 is different from that of the first embodiment. In the fourth embodiment, the first display 20 and the correction optical element 60 are disposed at substantially equal distances from the magnification reflective surface 41. The first display surface 21 and the correction reflective surface 61 are vertically aligned with orientations to face the magnification reflective surface 41. The distance from the first incident area 42 to the first display surface 21 is substantially the same as the distance from the second incident area 43 to the correction reflective surface 61. The correction optical element 60 is located on the opposite side of the windshield WS with respect to the first display surface 21 in a state where the HUD device 400 is mounted on the vehicle A. The correction optical element 60 is disposed below the first display 20.

As in the fourth embodiment, while the distance from the magnification reflective surface 41 to the first display surface 21 and the distance from the magnification reflective surface 41 to the correction reflective surface 61 are equal, the same effects as in the first embodiment can be obtained. The imaging performance can be secured for each of the near virtual image 29 and the far virtual image 39.

### Fifth Embodiment

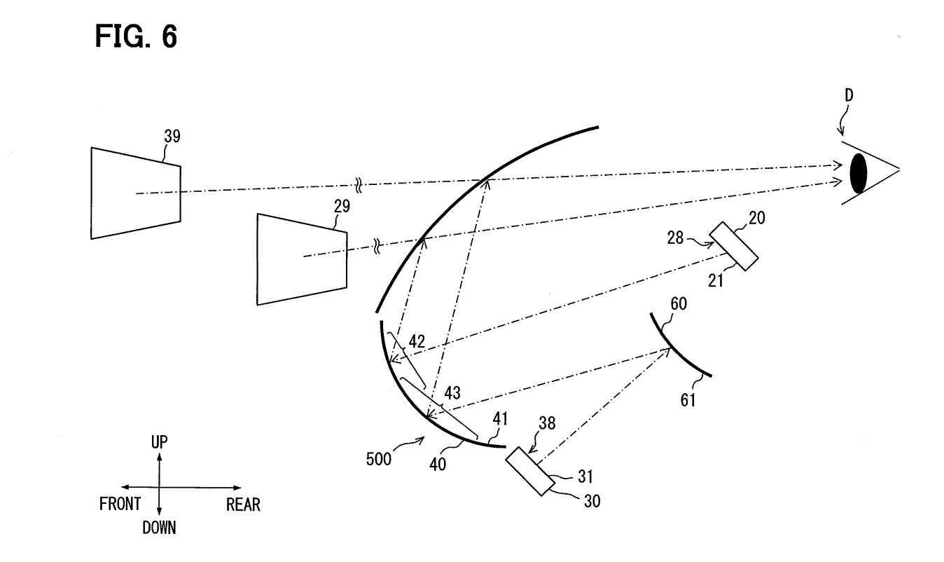

A fifth embodiment of the present disclosure shown in FIG. 6 is still another modification of the fourth embodiment. In the HUD device 500 of the fifth embodiment, the first display 20 is farther from the magnification optical element 40 compared with the fourth embodiment, and is positioned on the back side of the correction optical element 60 where the correction reflective surface 61 is not formed. Therefore, the distance from the first incident area 42 to the first display surface 21 is longer than the distance from the second incident area 43 to the correction reflective surface 61.

The correction optical element 60 is provided at a position not overlapping the optical path of the light of the near display image 28 traveling from the first display surface 21 to the first incident area 42. The correction optical element 60 is located closer to the first display surface 21 than the second incident area 43. Further, the second display surface 31 of the second display 30 is located on the opposite side of the first display surface 21 with respect to the correction optical element 60.

When the first display surface 21 is provided at a position farther from the magnification reflective surface 41 than the correction optical element 60 as in the fifth embodiment, the same effect as the fourth embodiment can be obtained. The imaging performance can be secured for each of the near virtual image 29 and the far virtual images 39.

### Other Embodiments

Although the embodiments of the present disclosure have been described above, the present disclosure is not construed as being limited to the above-described embodiments, and can be applied to various embodiments and combinations within a scope that does not depart from the spirit of the present disclosure.

In the above embodiment, a display formed by combining a liquid crystal display panel and a backlight is adopted as a configuration for emitting and displaying each display image. However, the configuration of the display may be changed appropriately. For example, an organic EL (Electroluminescence) may be used for a display to emit light to display each display image. In addition, the first display surface and the second display surface may be provided on one display.

At least one of the first display surface and the second display surface may be a projection surface (screen) on which an image is projected by a projection device. The projection device may be an LCD (Liquid Crystal Display) projector, a laser projector, a DLP (Digital Light Processing (registered trademark)) projector, or the like.

In the above embodiment, the HUD device is a bifocal HUD that forms virtual images at two different focal points. However, the HUD device may be a multi-focus HUD in which virtual images are formed at three or more focal points by projecting light of three or more display images onto a projection area. Also, the imaging position can be changed as appropriate. For example, a far virtual image may be imaged at a position of about 5 to 7 m from the eye point.

In the above embodiment, each display image is displayed in color. However, the display image and the virtual image may be a design in which light emission is displayed in a single color. Furthermore, the sizes of the display image and the virtual image may be changed as appropriate. Also, the range in which each virtual image can be displayed may be long in the vertical direction. In addition, the imaging positions and orientations of the far virtual image and the near virtual image may be changed as appropriate.

The configuration of the optical system used in the HUD device may be changed as appropriate. For example, the correction optical element may be a reflective configuration, a transmissive configuration, and a configuration having both reflection and transmission. In addition, the correction optical element (far correction optical element), the near correction optical element, and the magnification optical element may not be one each. The number of reflective mirrors and the number of lenses provided in the HUD device may be changed as appropriate. For example, multiple far correction optical elements or multiple near correction optical elements may be disposed on each light path. In addition, other magnification optical elements may be further provided in addition to the magnification optical element 40 (see FIG. 1 etc.) shared for display of the near virtual image and the far virtual image. In addition, the correction optical element may have a function of enhancing the magnification ratio of the far virtual image by an optical action that enlarges the light of the far display image, similarly to the magnification optical element.

Furthermore, the correction optical element (far correction optical element) may be disposed between the magnification optical element and the projection area in the optical path of the light of the far display image. Similarly, the near correction optical element may be disposed between the magnification optical element and the projection area in the optical path of the light of the near display image. Thus, the optical correction may be performed after reflection at the magnification optical element and after each optical path is clearly separated.

The shapes of the reflective surface and the refractive surface in the correction optical element may be appropriately changed so as to exert an effective correction action. It is desirable that the reflective surface and the refractive surface have a free-form surface shape in order to maximize the correction action. However, if sufficient correction action can be exhibited, toroidal shape or cylindrical shape etc. may be used to reduce the manufacturing cost.

The optical lens of the second embodiment is provided at a position closer to the second display surface than the magnification reflective surface. However, the optical lens may be provided at a position closer to the magnification reflective surface than the second display surface. Further, the first incident area and the second incident area defined in the magnification reflective surface may be separated from each other.

In the above embodiment, the optical paths of the near display image and the far display image incident on the magnification reflective surface are substantially parallel. However, the layout of optical paths inside the HUD device may be changed as appropriate. For example, a layout in which two optical paths cross each other may be employed.

The mobile unit on which the HUD device is mounted may be a ship, an aircraft, a transport device, or the like other than a vehicle. In addition, the occupant of the mobile unit may not be the driver who steers the mobile unit.

What is claimed is:

1. A head-up display device that projects two display images on a windshield of a mobile unit to display virtual images of the two display images at different positions to be visible for an occupant of the mobile unit, comprising:
a first display surface configured to emit a near display image to display a near virtual image at a position near the windshield, of the two display images;
a second display surface configured to emit a far display image to display a far virtual image at a position farther from the windshield than the near virtual image, of the two display images;
a magnification optical element configured to magnify light emitted from the first display surface and the second display surface and to reflect the light toward the windshield to form the near virtual image and the far virtual image respectively magnified from the near display image and the far display image; and
a correction optical element provided in an optical path of the light of the far display image, wherein
the correction optical element is configured to correct an optical influence, together with the magnification optical element, to be generated in the far virtual image by a reflection on the windshield,
the magnification optical element has a first incident area on which the light of the near display image is incident and a second incident area on which the light of the far display image is incident, and
at least a part of the first incident area overlaps with at least a part of the second incident area.

2. The head-up display device according to claim 1, wherein
the correction optical element is disposed between the second display surface and the magnification optical element in the optical path of the light of the far display image.

3. The head-up display device according to claim 1, wherein
the correction optical element has a reflective surface to reflect the light of the far display image emitted from the second display surface toward the magnification optical element.

4. The head-up display device according to claim 3, wherein
the correction optical element, in a state of being mounted on the mobile unit, is located opposite to the windshield with respect to the first display surface.

5. The head-up display device according to claim 3, wherein
the second display surface is located opposite to the first display surface with respect to the correction optical element.

6. The head-up display device according to claim 1, wherein
the correction optical element has a refractive surface to refract light of the far display image emitted from the second display surface and to emit the light toward the magnification optical element.

7. A head-up display device that projects two display images on a windshield of a mobile unit to display virtual images of the two display images at different positions to be visible for an occupant of the mobile unit, comprising:
a first display surface configured to emit a near display image to display a near virtual image at a position near the windshield, of the two display images;
a second display surface configured to emit a far display image to display a far virtual image at a position farther from the windshield than the near virtual image, of the two display images;
a magnification optical element configured to magnify light emitted from the first display surface and the second display surface and to reflect the light toward the windshield to form the near virtual image and the far virtual image respectively magnified from the near display image and the far display image; and
a correction optical element provided in an optical path of the light of the far display image, wherein
the correction optical element is configured to correct an optical influence, together with the magnification optical element, to be generated in the far virtual image by a reflection on the windshield,
the correction optical element has a reflective surface to reflect the light of the far display image emitted from the second display surface toward the magnification optical element, and
the correction optical element, in a state of being mounted on the mobile unit, is located opposite to the windshield with respect to the first display surface.

8. A head-up display device that projects two display images on a windshield of a mobile unit to display virtual images of the two display images at different positions to be visible for an occupant of the mobile unit, comprising:
a first display surface configured to emit a near display image to display a near virtual image at a position near the windshield, of the two display images;
a second display surface configured to emit a far display image to display a far virtual image at a position farther from the windshield than the near virtual image, of the two display images;
a magnification optical element configured to magnify light emitted from the first display surface and the second display surface and to reflect the light toward the windshield to form the near virtual image and the far virtual image respectively magnified from the near display image and the far display image; and
a correction optical element provided in an optical path of the light of the far display image, wherein
the correction optical element is configured to correct an optical influence, together with the magnification optical element, to be generated in the far virtual image by a reflection on the windshield,
the correction optical element has a reflective surface to reflect the light of the far display image emitted from the second display surface toward the magnification optical element, and
the second display surface is located opposite to the first display surface with respect to the correction optical element.

9. The head-up display device according to claim 7, wherein
the correction optical element is disposed between the second display surface and the magnification optical element in the optical path of the light of the far display image.

10. The head-up display device according to claim 1, further comprising:
a near correction optical element provided in an optical path of the light of the near display image, wherein the near correction optical element is configured to correct an optical influence, together with the magnification optical element, to be generated in the near virtual image by a reflection on the windshield.
